(19) United States
(12) Patent Application Publication
(10) Pub. No.: US 2008/0029338 A1
(43) Pub. Date: Feb. 7, 2008

(54) Mechanical automatic recoil repelling cable escape system

(76) Inventors: Floro Rosal, La Puente, CA (US); Frederick J. Malcolm, La Puente, CA (US); Anselmo Jaurique, Los Angeles, CA (US)

Correspondence Address: Donald W. Meeker;Patent Agent, 924 East Ocean Front #E, Newport Beach, CA, 92661, US

(21) Appl. No.: 11/497,949

(22) Filed: Aug. 1, 2006

(51) Int. Cl. A62B 1/06

(52) U.S. Cl. 182/70

(57) ABSTRACT

A mechanical repelling system enables a user to repel down an outside of a building to escape the building. A single cable with a harness is wound through a double array of block and tackle rollers, including a transverse array of moving rollers and an aligned and paired array of fixed rollers. The moving array of rollers attached to a descent speed controlling damper piston with a cable return compression spring.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

### Field of the Invention

The present invention relates to fire escape systems and particularly to a multiple-use cable fire escape system developed to provide an alternative route of exit from a multi-story structure for alternately and rapidly lowering people one after another in case of a fire or other emergency; said fire escape system comprises a mounting frame assembly for attachment to the roof or side of a building, a webbed cradle at the end of a cable for lowering persons to the ground, a cable storage assembly, a cable winding and run out system, a slider block and guide rail, a dampener and return spring assembly. Description of Related Art Including Information Disclosed Under 37 CFR 1.97 and 1.98

When escaping from a burning building it is often necessary for a human being to exit from the window if the stairways or other means of exit are otherwise blocked by the fire. Rooms on the upper floors of buildings are sometimes specially provided with a fire escape apparatus comprising a drum fixed to a secure mounting and a length of rope or cable wound around the drum and provided with a harness; an automatic brake is provided in the drum to limit the speed of rotation of the drum to a safe speed. In use a person throws one end of the cable out of the room and then secures himself in the harness attached to the other end of the cable. He is then able to descend to the ground at a safe speed limited by the automatic brake. The cable then needs to be rewound for a second use.

Many devices have been provided with a hand crank for rewinding the cable, which is simply too slow in times of crisis. Devices have been developed that have two cables, wherein the weight of a person descending on a first cable raises a second seat to the top of the building for another person to use for escape. A more rapid cable rewind is necessary for saving as many people as possible. Hydraulic or power driven rewind systems have been developed so a greater number of persons can lower themselves safely to the ground in the event of a fire. The prior art does not provide an adequate non-powered repelling system for escaping a fire with a rapid automatic rewind for multiple rescues.

U.S. Pat. No. #6,450,293, issued Sep. 17, 2002 to Wu, is for a fire escape device which includes first and second cable drums rotatably mounted on a mounting shaft and spaced apart from each other axially, first and second support cables respectively wound around hub portions of the cable drums, and a coupling mechanism disposed between the cable drums to interconnect releasably the same. The first support cable is unreeled to generate a jerking force to permit rotation of the second cable drum with the first cable drum. Unreeling of the second support cable can rotate the first and second cable drums to reel the first support cable. Thus, alternately lowering people one after another from an elevated floor to a safe location can be achieved.

U.S. Pat. No. #4,611,688, issued Sep. 16, 1986 to Sekhar, claims a rewindable fire escape for the lowering of a plurality of escapees to the ground. Included in the present structure is a shaft, a spool journalled upon the shaft, a cable having a first and second end, the first end secured to the journal of the spool, in which the cable has a length generally equal to the distance of the spool above the ground. Also provided are body securement means affixed to the second end of the cable for use by the escapee. Further provided is a flywheel which is rotationally coupled to the spool; the flywheel constitutes a means for acquiring and storing angular momentum developed therein during descent of the cable to the ground. Also included in the present inventive fire escape are means for rotationally transferring the angular momentum from the flywheel back to the spool to thereby effectuate the rewinding of the cable so that the body securement means can thereby be used by the next escapee. Further provided are descent and ascent angular velocity limit means.

U.S. Pat. No. #5,494,133, issued Feb. 27, 1996 to Green, describes a controlled weight-lowering device which allows an individual to descend from a building at a predetermined rate of descent. The device can be permanently attached to the building or it can be portable. The device has an outer bracket which is securely attached to the inside of the building. Rotating about a shaft attached to the bracket is a cylindrical winding drum. The drum has a rope wound around it that is attached to a harness. The individual puts on the harness he desires to descend. Inside the winding drum is an inner gear pump and valve mechanism which is surrounded by an oil reservoir. Oil is allowed to go into the gear set chamber and circulates past the gears. The rate of flow of the oil out of the gear set chamber is regulated by a spring biased tapered piston. As the strength of the spring biasing is set on the piston, the rate of flow of oil within the gear set chamber is regulated. Because the gear set is connected to the cylindrical axis of the winding drum, controlling the rate of flow of oil, which controls the rate of rotation of the gears, also controls the rate of rotation of the drum.

U.S. Pat. No. #4,473,132, issued Sep. 25, 1984 to Schwing, discloses a fire escape mechanism and method for safely removing occupants of multi-story buildings under conditions of fire and catastrophe by allowing one occupant at a time to don a harness attached to the device and safely jump, with his rate of descent controlled so that he reaches the ground safely. The device has a rigid frame in which a rotatable shaft is positioned. On the shaft are mounted two drums. On each drum is wound enough cable to reach the ground from the height of installation of the device. Each drum has its cable wound in a direction of rotation opposite from that of its mate. A drag element acts on the shaft to limit the rotational velocity of the shaft, and thereby the rate of fall of the escaping occupant, to a speed which will not injure the occupant on contacting the earth. Only one user at a time will be able to occupy the apparatus since the cable end of the second cable is hidden under the first cable and is not accessible until the first cable has been completely unwound. A pair of elevator type tubular conduits are provided, each with a walk-in shuttle, to enclose each occupant on his descent and a keyway to prevent rotation of the occupant-containing shuttle during its descent and ascent.

U.S. Pat. No. #6,626,265, issued Sep. 30, 2003 to Devine, indicates a controlled descent apparatus that includes a cable which is wound on a spool and is unwound from the spool by the weight of a person to effect the descent. To limit the rate of descent, the spool turns as the cable is unwound and drives a positive displacement pump the output of which is through a flow control valve. A secondary braking system is designed to provide a smooth transition between the systems. The cable is guided through an opening, such as a window, by an arm which is formed by inner and outer sections pivotally connected to each other with the inner arm pivotally connected relative to the wall so that the arm may be placed in a compact stored condition. The release of a latch permits the arm to self-deploy into an active position.

U.S. Pat. No. #4,653,609, issued Mar. 31, 1987 to Devine, puts forth a controlled descent apparatus for lowering a person from an elevated place that includes a cable which is wound on a drum and is unwound from the drum by the weight of the person to effect the descent. To limit the rate of descent, the drum turns as the cable is unwound and drives a positive displacement pump the output of which is through a flow control valve. The latter is set to permit a pre-selected maximum rate of flow so that the drum turns at a correlated maximum speed and thus limits the rate at which the cable is paid out during the descent. In the unlikely event that the valve fails to limit the speed of the drum, a centrifugally operated brake is automatically energized at a somewhat higher speed of the drum whereby the descent continues at a faster but still a safe rate. The cable is guided through an opening, such as a window, in an outside wall by an arm which is formed by inner and outer sections pivotally connected to each other with the inner arm pivotally connected relative to the wall so that the arm may be placed in a compact stored condition. To use the apparatus, the outer arm section first is swung down and latched to the inner arm section in a ready position and then the arm is swung to an active position in which the outer section projects through the window. The apparatus also includes alternative power and manual means to rewind the cable on the drum for the next descent.

U.S. Pat. No. #4,437,546, issued Mar. 20, 1984 to Marinoff, concerns a fire escape device that includes a housing with a reel journalled for rotational movement within the housing. A cable is fixed at one end thereof to the reel and is wound upon the reel with the other end thereof extending through an opening in the housing. The housing can be connected to a fixed position on an elevated structure and a harness which is carried at the free end of the cable is used for supporting a human body. A fluid pump is carried by the housing for pumping fluid from a sump reservoir through an orifice. The rotor of the pump is coupled with the reel for retarding and impeding free rotational movement of the reel so that the cable unwinds at a controlled rate of speed which is in direct proportion to the amount of fluid being pumped through the orifice. Upon complete descent, the user unfastens the harness to allow the next user, stationed with the device, to rewind the cable onto the drum. This is accomplished through the rewind mechanism. The rewind mechanism includes a crank with handle. An automatic rewind mechanism such as by spring loading reel, may also be provided.

What is needed is a non-powered repelling system for escaping a fire with a rapid automatic rewind for multiple rescues.

### BRIEF SUMMARY OF THE INVENTION

An object of the present invention is to provide a double row of interacting roller blocks with a single cable in a personal escape repelling system for a highly effective rapid mechanical repelling system for escaping a fire with a rapid automatic rewind for multiple rescues.

In brief, a mechanical repelling system for repelling down an outside of a building comprises multiple parallel block and tackle rollers attached side by side in an aligned array inside a frame attached to a building with a proximal set of rollers of each of the block and tackle array fixed to the frame aligned transversely across the frame and a moving array of mating rollers riding on a spaced pair of rails on the longitudinal sides of the frame with the moving array of rollers attached to a damper piston rod with an outer compression spring sleeve secured to a proximal end of the frame, the moving array of rollers normally spaced apart from the fixed array of rollers in a storage mode, and having a single cable wound between each pair of rollers, comprising a proximal fixed roller and an aligned distal moving roller, across the array of multiple parallel block and tackle rollers and out of a distal end of the frame over a roller, with a mesh cradle or other type of harness attached to an end of the cable for a user to repel down a side of a building to escape a fire or other adverse occurrence requiring a rapid exit from upper stories of a building when normal exit routes are not operable so that when a user in the cradle or harness jumps from the building, the cable plays out drawing the moving array of rollers toward the fixed array of rollers with the damper piston rod controlling a slow descent of the user and the compression spring being compressed by the moving array, and when the user is on the ground and removes the harness, the compression spring releases to push the moving array of rollers away from the fixed array of rollers to draw the cable back up into the frame with the harness on the end of the cable returning back up to the frame to enable a second user to put on the harness and repel down the building.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a side elevational view of the mechanical repelling system of the present invention shown with a side of the frame open for viewing the interior indicating the damper rod and cylinder attached between the moving rollers and the fixed rollers;

FIG. 2 is a side elevational view of the mechanical repelling system of the present invention shown with a side of the frame open for viewing the interior indicating the damper rod and cylinder attached between the moving rollers and the frame;

FIG. 3 is an elevational view of the mechanical repelling system of FIG. 1 stored with the harness in a recess above a window;

FIG. 4 is a perspective view of the mechanical repelling system of FIG. 2;

FIG. 5 in an elevational view of a user repelling down a building to escape the building using the mechanical repelling escape system of the present invention with the system mounted on a sloped roof of the building;

FIG. 6 in an elevational view of a user repelling down a building to escape the building using the mechanical repelling escape system of the present invention with the system mounted on a flat roof of the building;

FIG. 7 in an elevational view of a user repelling down a building to escape the building using the mechanical repelling escape system of the present invention with the system mounted on a side wall of the building.

### DETAILED DESCRIPTION OF THE INVENTION

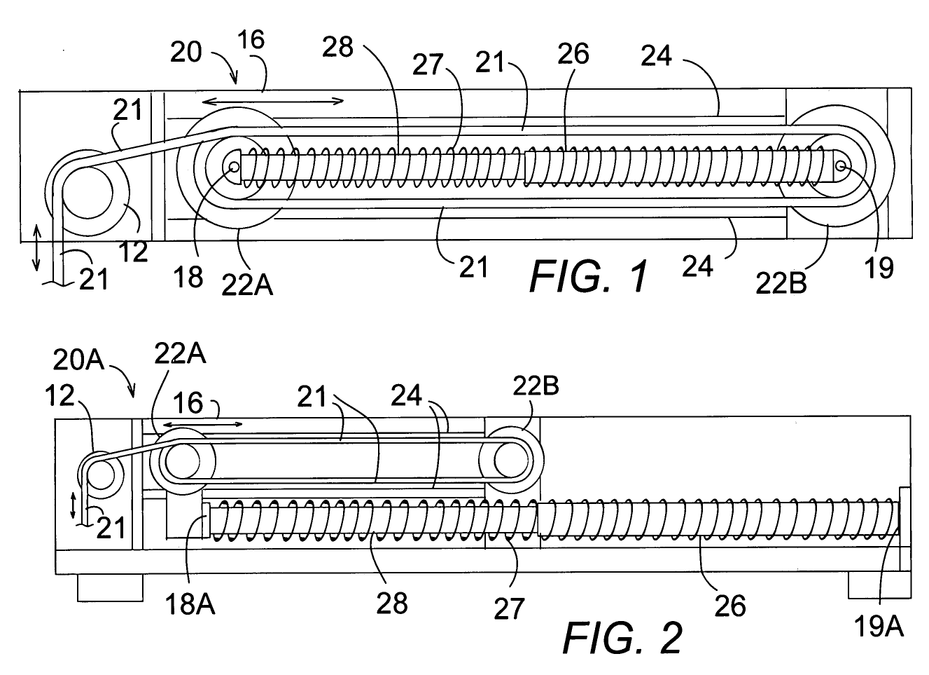

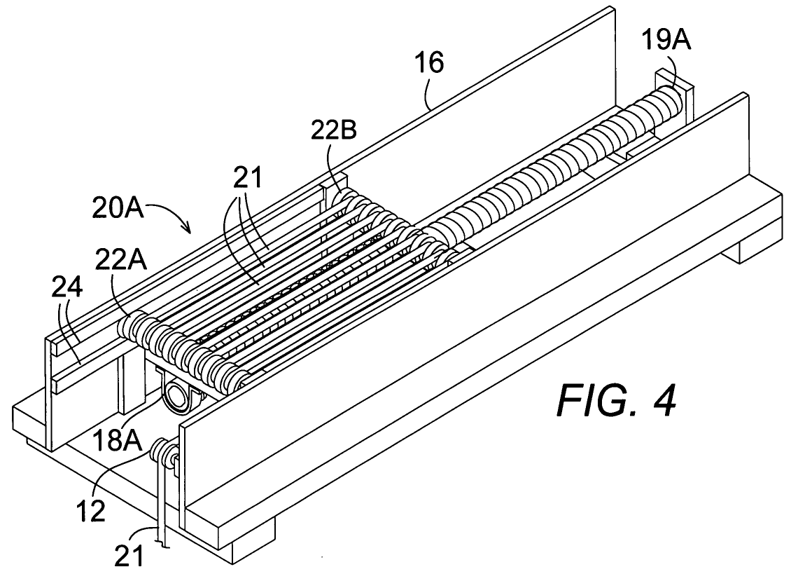

In FIGS. 1-7, a mechanical repelling system 20 and 20A for a user to repel down an outside of a building 40 to escape the building comprises a harness 30 on a single cable 21 wound through a double array of block and tackle rollers 22A and 22B including a transverse array of moving rollers 22A and an aligned and paired array of fixed rollers 22B and a descent speed controlling damper piston 26 with a cable return compression spring 27.

A series of parallel block and tackle rollers attach side by side in an aligned array inside a frame 16 attached to a building 40 with a proximal set of rollers 22B of each of the block and tackle array fixed to the frame 16 aligned transversely across the frame and a moving array of mating rollers 22A riding on a spaced pair of rails 24 on the longitudinal sides of the frame, the moving array of rollers normally spaced apart from the fixed array of rollers in a storage mode, is in FIGS. 1-4.

A damper piston rod 28 and piston cylinder 26 with an outer compression spring 27 sleeve is secured between a proximal end of the frame and the moving array of rollers.

A single cable 21 is attached at a proximal end to the frame 16. The single cable 21 is wound between each pair of rollers 22A and 22B, which pair each comprise a proximal fixed roller 22B and an aligned distal moving roller 22A. The single cable 21 is wound across the array of multiple parallel block and tackle rollers and out of a distal end of the frame over a roller 12.

A harness 30 attaches to a distal end of the cable 21 for a user to attach the harness to the body of the user to repel down a side of a building 40 to escape a fire or other adverse occurrence requiring a rapid exit from upper stories of a building when normal exit routes are not operable. The harness 30 preferably comprises a mesh cradle.

In FIG. 1, the damper piston rod 28 and cylinder 26 attaches between the moving array of rollers 22A and the fixed array of rollers 22B.

In FIG. 2, the damper piston rod 28 and cylinder 26 attaches between the moving array of rollers 22A and the proximal end of the frame 16.

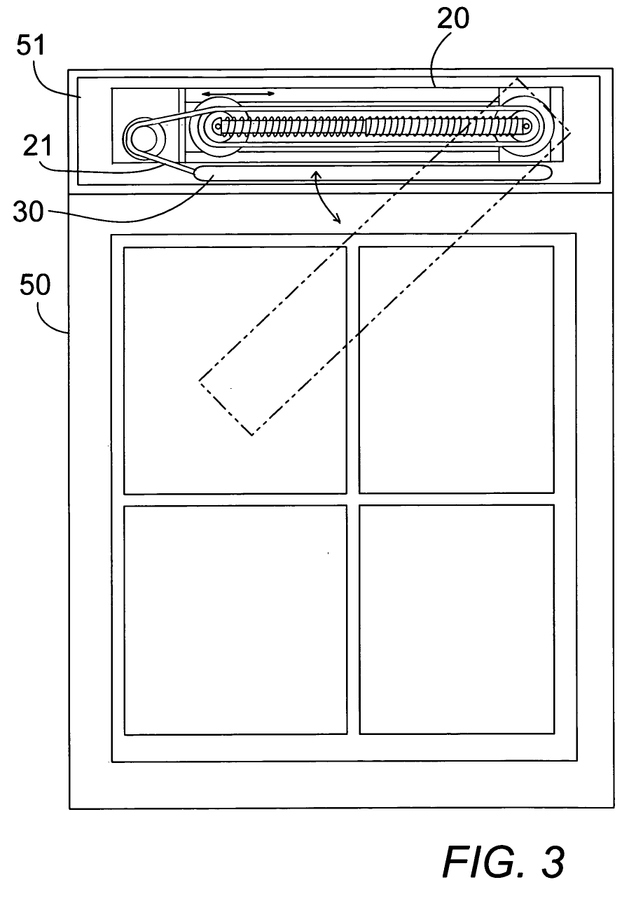

In FIG. 3, the embodiment of FIG. 1 is stored in a recess 51 above a window 50 along with the harness 30 and may pivot downward as indicated by the dashed lines.

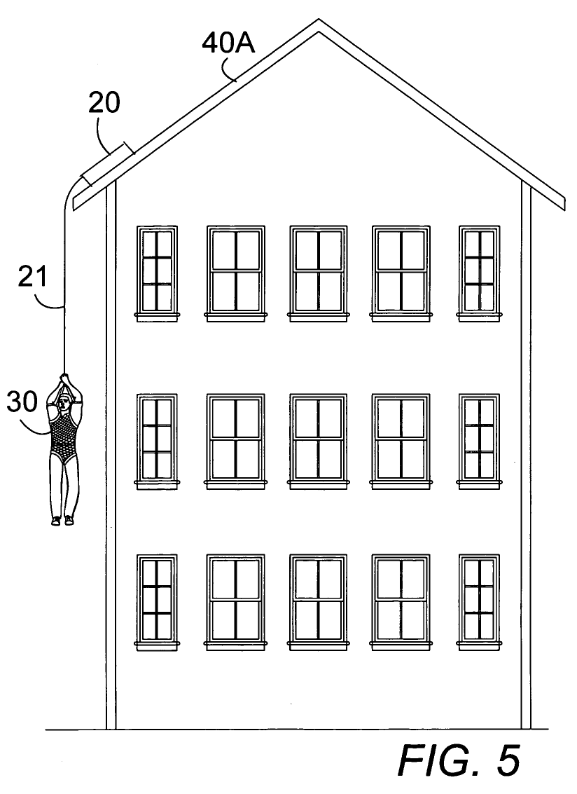

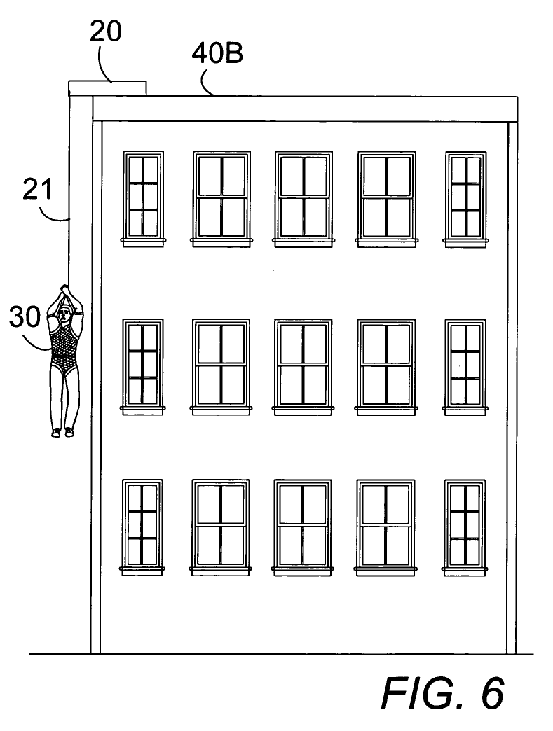

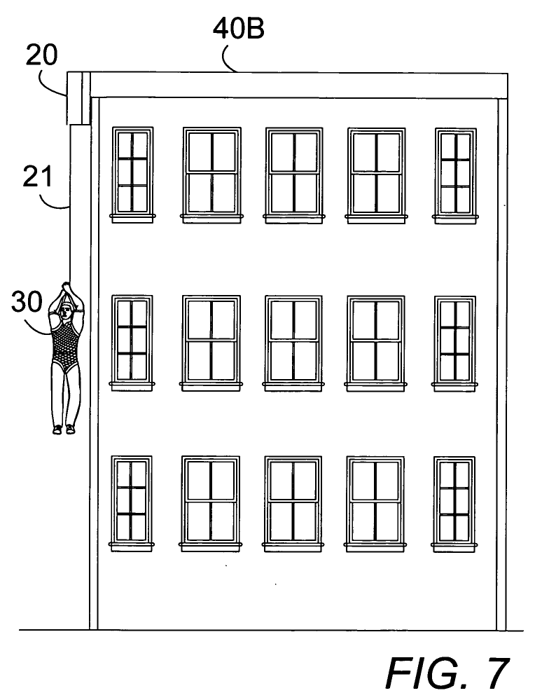

In FIG. 5, the mechanical repelling system 20 is stored on a pitched roof of a building 40A and is shown with a user descending in a harness 30 suspended by the cable 21. In FIG. 6, the mechanical repelling system 20 is stored on a flat roof of a building 40B and is shown with a user descending in a harness 30 suspended by the cable 21. In FIG. 7, the mechanical repelling system 20 is stored on a side wall adjacent to a roof of a building 40B and is shown with a user descending in a harness 30 suspended by the cable 21.

In use in FIGS. 5-7, a user in the cradle or harness 30 jumps from the building 40, the cable 21 plays out drawing the moving array of rollers 21A toward the fixed array of rollers 21B with the damper piston rod 28 and cylinder 26 being compressed by the moving array to control a slow descent of the user and the compression spring 27 being compressed by the moving array. When the user is on the ground and removes the harness 30, the compression spring 27 releases to push the moving array of rollers 22A away from the fixed array of rollers 22B to draw the cable 21 back up into the array of block and tackle rollers with the harness on the end of the cable returning back up to the frame to enable a second user to put on the harness and repel down the building.

It is understood that the preceding description is given merely by way of illustration and not in limitation of the invention and that various modifications may be made thereto without departing from the spirit of the invention as claimed.

What is claimed is:

1. A mechanical repelling system for a user to repel down an outside of a building to escape the building, the system comprising:
a series of parallel block and tackle rollers attached side by side in an aligned array inside a frame attached to a building with a proximal set of rollers of each of the block and tackle array fixed to the frame aligned transversely across the frame and a moving array of paired rollers riding on a spaced pair of rails on the longitudinal sides of the frame, the moving array of rollers normally spaced apart from the fixed array of rollers in a storage mode;
a damper piston rod and cylinder with an outer compression spring sleeve secured between a proximal end of the frame and the moving array of rollers;
a single cable attached at a proximal end to the frame, the single cable wound between each pair of rollers, which pair each comprise a proximal fixed roller and an aligned distal moving roller, the single cable wound across the array of multiple parallel block and tackle rollers and out of a distal end of the frame over a roller;
a harness attached to a distal end of the cable for a user to attach the harness to the body of the user to repel down a side of a building to escape a fire or other adverse occurrence requiring a rapid exit from upper stories of a building when normal exit routes are not operable so that when a user in the cradle or harness jumps from the building, the cable plays out drawing the moving array of rollers toward the fixed array of rollers with the damper piston rod and cylinder being compressed by the moving array to control a slow descent of the user and the compression spring being compressed by the moving array, and after the user on the ground removes and releases the harness, the compression spring releasing to push the moving array of rollers away from the fixed array of rollers to draw the cable back up into the array of block and tackle rollers with the harness on the end of the cable returning back up to the frame to enable a second user to put on the harness and repel down the building.

2. The system of claim 1 wherein the damper piston rod and cylinder attaches between the moving array of rollers and the fixed array of rollers.

3. The system of claim 1 wherein the harness comprises a mesh cradle.
